(19) United States
(12) Patent Application Publication
(10) Pub. No.: US 2008/0123047 A1
(43) Pub. Date: May 29, 2008

(54) Lens of diving mask

(76) Inventor: Jung-Chin Ku, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/605,422

(22) Filed: Nov. 29, 2006

(51) Int. Cl. G02C 7/02

(52) U.S. Cl. 351/43

(57) ABSTRACT

The present invention relates to an improved lens of a diving mask that includes a plurality of layers of glass and a transparent gluing film combined between the layers of glass, and the gluing film comes with the characteristics of high elasticity and high tenacity, such that the invention not only can improve the shock-resistance of the lens of the diving mask, but also can adhere the broken pieces or particles of glass onto the gluing film to prevent the broke glass from flying over or hurting a diver's eyes or face when the lens is broken accidentally, so as to achieve a safe protection effect.

### BACKGROUND OF THE INVENTION

1. Field of the Invention

The present invention relates to an improved lens of a diving mask, and more particularly to a lens of a diving mask comprising a plurality of layers of glass and a gluing film layer disposed between the layers of glass, such that the invention not only improves the shock-resistance of the lens of the diving mask, but also prevents any broken glass from flying over or hurting a diver's eyes or face when the lens of the diving mask is broken accidentally, so as to achieve a safe protection effect.

2. Description of the Related Art

In general, a diving mask is a necessary tool for divers to view or search objects in the sea and protect the diver's eyes. However, it is inevitable to have collisions such as being hit by large fishes or contacted by coral reefs and rocks during the use of the diving mask, and such collisions often crack or break the lens of the diving mask or even jeopardize the diver's safety. Therefore, many diving mask manufacturers spare no effort to improve the materials of the lens, in hope of enhancing the safety. The present tempered-glass lens (or generally known as safety-glass lens) is one of the most popular lenses used for making diving masks. However, divers find out from a long time of use that the tempered-glass lens is not completely free of cracking or breaking, although the tempered-glass lens comes with better strength and shock resistance. Particularly, when the tempered-glass lens is hit at a certain angle and cracked, the broken pieces of glass will fly over or even hurt the diver's eyes, and thus such tempered-glass mask still bears certain risk in its use.

In view of the foregoing shortcomings of the prior art, the inventor of the present invention based on years of experience in the related industry to conduct extensive researches and experience, and finally developed an improved lens of a diving mask in accordance with the present invention.

### SUMMARY OF THE INVENTION

The primary objective of the present invention is to overcome the shortcomings of the prior art by providing an improved lens of a diving mask that comprises a plurality of layers of glass and a transparent gluing film combined between the layers of glass, and the gluing film comes with the characteristics of high elasticity and high tenacity, such that the invention not only improves the shock-resistance of the lens of the diving mask, but also adheres the broken pieces or particles of glass directly onto the gluing film to prevent the broken glass from flying all over or hurting a diver's eyes or face when the lens is broken accidentally, so as to achieve a safe protection effect.

Another objective of the present invention is to provide a simple structure of a lens of a diving mask to improve the safety of using the diving mask.

To make it easier for our examiner to understand the objectives, characteristics and effects of the present invention, a preferred embodiment with accompanying drawings are used for a detailed description of the invention as follows.

### BRIEF DESCRIPTION OF THE DRAWINGS

FIG. 1 is a schematic view of a diving mask of the present invention; and

FIG. 2 is a sectional view of a lens of a diving mask of the present invention.

### DETAILED DESCRIPTION OF THE PREFERRED EMBODIMENTS

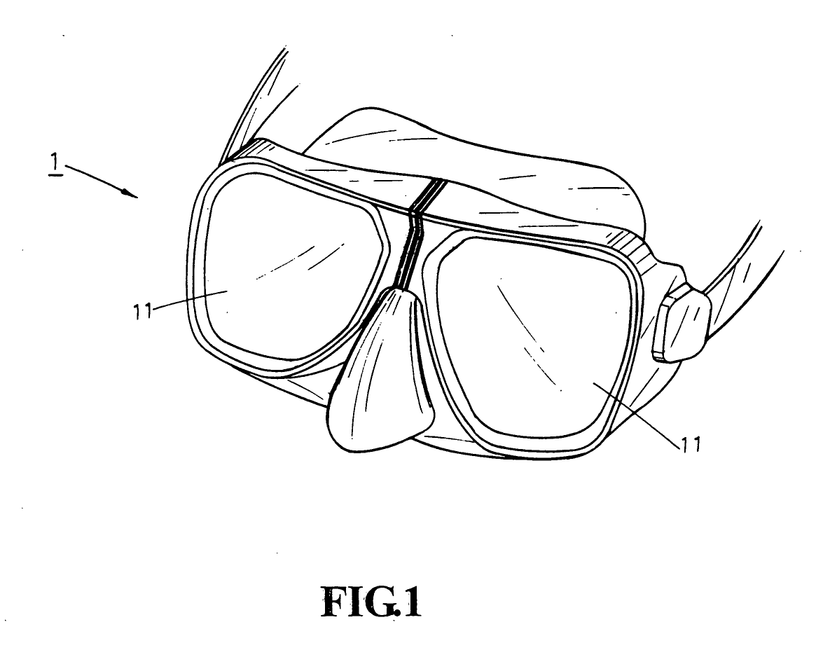

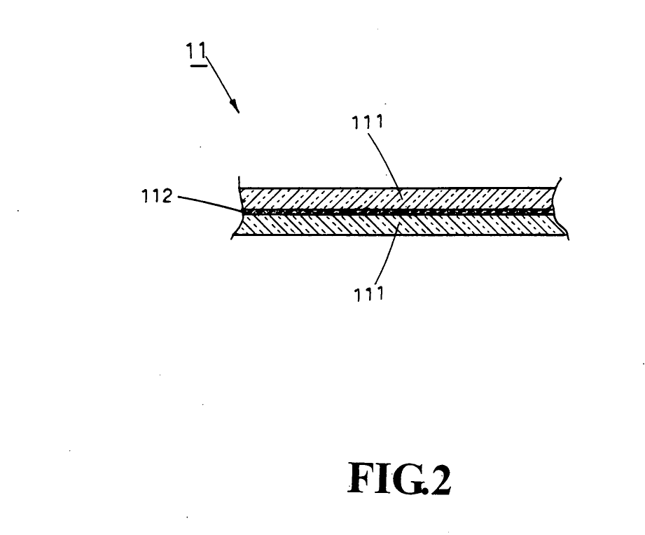

Referring to FIGS. 1 and 2 for an improved lens of a diving mask in accordance with the present invention, the lens 11 of the diving mask 1 comprises a plurality of layers of glass111, and a highly transparent, elastic and tenacious gluing film 112 combined between the layers of glass 111, wherein the gluing film 112 is made of a polyvinyl butyral (PVB) resin that has a strong adhesive effect on glass and provides a film with the features of high tenacity, elasticity and transparency to achieve the shock resistance effect for the lens 11 of the diving mask 1.

The layer of the gluing film 112 is a transparent thin film combined between layers of glass 111 to form the lens 11 of a diving mask 1, and such arrangement will not affect the normal operation of the diving mask 1. In addition, the gluing film 112 comes with the characteristics of high tenacity and elasticity, so broken pieces of glass produced by the layers of glass 11 will be adhered directly onto the gluing film 112, if the lens 11 is cracked or broken accidentally, so as to prevent the broken glass from flying over or hurting the diver's eyes and face.

In summation of the description above, the lens 11 of the diving mask 1 is made of a plurality of layers of glass 111 and a gluing film 112 combined between the layers of glass 11, such that any broken glass can be adhered directly onto the gluing film 112 if the lens 11 is broken, so as to prevent the broken glass from flying over or hurting a diver's eyes and face. The present invention definitely can overcome the shortcomings of the prior art and comply with the requirements of patent application.

What is claimed is:

1. An improved lens of a diving mask, comprising a plurality of layers of glass, and a highly transparent, elastic and tenacious gluing film.

2. The improved lens of a diving mask of claim 1, wherein said gluing film is made of a polyvinyl butyral (PVB) resin.
